(19) United States
(12) Patent Application Publication
(10) Pub. No.: US 2012/0006171 A1
(43) Pub. Date: Jan. 12, 2012

(54) SAW ASSEMBLY WITH SAFETY SHIELD FOR TABLE SAW

(75) Inventor: Chia-Sheng LIU, Taichung County (TW)

(73) Assignee: DURQ MACHINERY CORP., Shen Kang Hsiang (TW)

(21) Appl. No.: 12/876,584

(22) Filed: Sep. 7, 2010

(30) Foreign Application Priority Data
Jul. 7, 2010 (TW) 99122346

(51) Int. Cl. B27G 19/02; B23D 45/06

(52) U.S. Cl. 83/477.1; 83/478

(57) ABSTRACT

A saw assembly for a table saw includes a bracket, a driving unit swingingly connected with the bracket, a saw blade coupled to a driving shaft of the driving unit, which extends through an inclined guide slot of the bracket, an elevating unit mounted with the bracket and connected with the driving unit, and a shield pivotally mounted between the driving unit and the saw blade. When the driving unit is lifted or lowered by the actuation of the elevating unit, the saw blade can be moved upwards or downwards along the inclined guide slot of the bracket, and the shield can be rotated to keep the inclined slot of the bracket covered, thereby preventing a maintenance worker's hand from getting injured by the saw blade, and allowing the sawing chips of a workpiece to be collected effectively.

### BACKGROUND OF THE INVENTION

1. Field of the Invention

The present invention relates generally to a table saw, and more specifically to a saw assembly for a table saw, which has a safety means to prevent a maintenance worker from touching a saw blade during repair work.

2. Description of the Related Art

FIG. 1 shows a conventional saw assembly 10 for a table saw, comprising a bracket 11, an elevating unit 12 mounted with the bracket 11, a motor 13 slidably mounted with the bracket 11, and a saw blade 14. The driving shaft of the motor 13 is coupled to the saw blade 14 through an inclined guide slot 112 of the bracket 11, and the head portion of the motor 13 is connected with the elevating unit 12 such that the motor 13 is swingable relative to the bracket 11 by the actuation of the elevating unit 12 to move the saw blade 14 upwards and downwards along the inclined guide slot 112 of the bracket 11.

However, when the motor 13 and the saw blade 14 are lowered to a rest position along the inclined guide slot 112 of the bracket 11, as shown in FIG. 2, the upper part of the inclined guide slot 112 of the bracket 11 is uncovered. Under this circumstance, if the motor 13 or other components need to be repaired, a maintenance worker's hand may easily pass through the inclined guide slot 112 and accidentally get injured by the saw blade 14. In other words, it can be seen that the conventional saw assembly 10 is unsafe for the maintenance worker who is doing the repair work.

### SUMMARY OF THE INVENTION

It is one objective of the present invention to provide a saw assembly for a table saw, which has a safety shield to prevent a maintenance worker from getting injured by a saw blade, thereby enhancing safety of the maintenance worker during repair work.

It is another objective of the present invention to provide a saw assembly for a table saw, which can allow the sawing chips of a workpiece to be collected effectively.

To achieve these objectives of the present invention, the saw assembly provided by the present invention comprises a bracket, a driving unit swingingly connected with the bracket, a saw blade coupled to a driving shaft of the driving unit, which extends through an inclined guide slot of the bracket, an elevating unit mounted with the bracket and connected with the driving unit for driving the driving unit to swing such that the saw blade is reciprocally moveable along the inclined guide slot, and a shield pivotally connected between the driving unit and the saw blade and covering the inclined guide slot of the bracket. The shield has two curved edges respectively abutted against a first stop portion of the bracket adjacent to a top end of the inclined guide slot and a second stop portion of the bracket adjacent to a bottom end of the inclined guide slot.

By means of the aforesaid design, when the saw blade is moved to a working position or lowered to a rest position, the shield is pivotable during the movement of the saw blade to cover the inclined guide slot of the bracket, such that a maintenance worker's hand can't pass through the inclined guide slot of the bracket during repair work to prevent from getting injured by the saw blade; and further, the sawing chips of a workpiece can't pass through the inclined guide slot of the bracket due to the obstruction of the shield so as to be effectively collected.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially exploded view of a saw assembly according to a prior art;

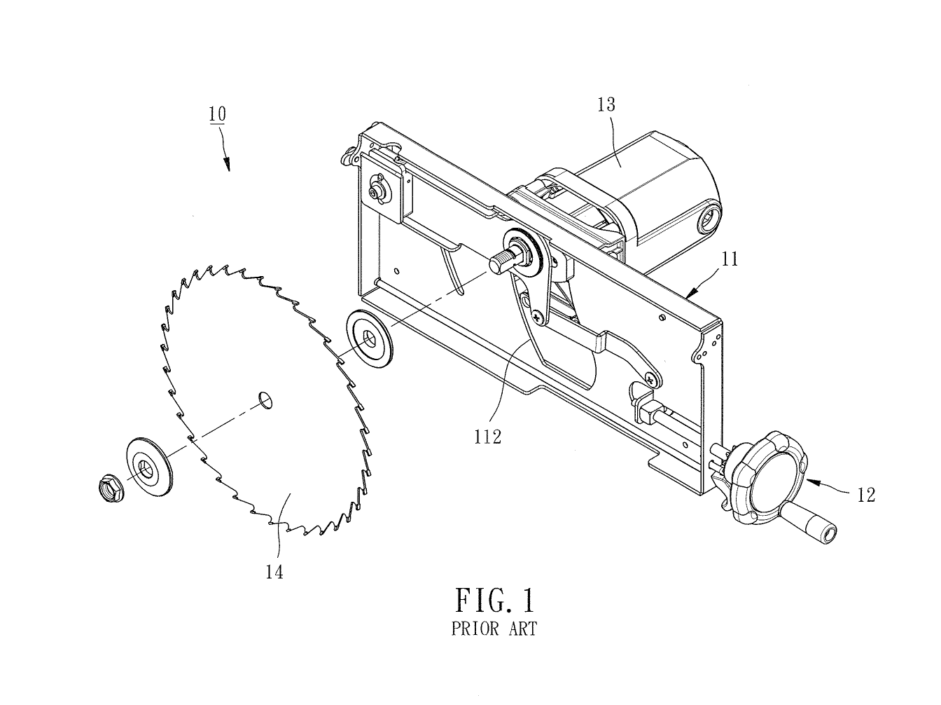

FIG. 2 is a lateral view of the saw assembly according to the prior art, showing the saw blade is located at the rest position;

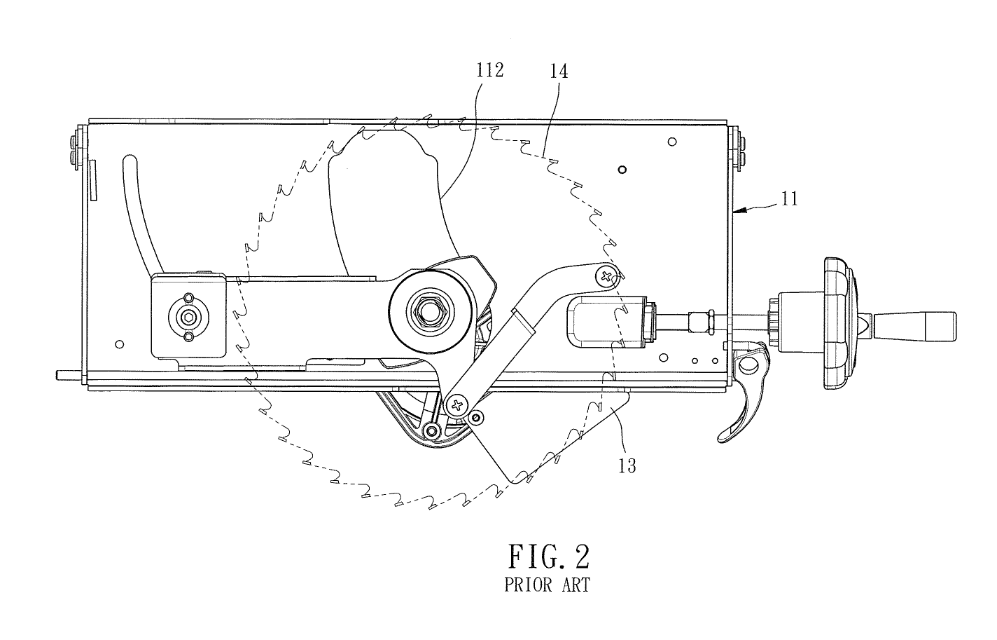

FIG. 3 is a partially exploded view of a saw assembly according to a preferred embodiment of the present invention;

FIG. 4 is a perspective view of the saw assembly according to the preferred embodiment of the present invention, showing the rear side of the saw assembly;

FIG. 5 is a lateral view of the saw assembly according to the preferred embodiment of the present invention, showing the saw blade is located at the working position;

FIG. 6 is similar to FIG. 5, showing the saw blade is moved from the working position to the rest position; and

FIG. 7 is similar to FIG. 6, showing the saw blade is located at the rest position.

### DETAILED DESCRIPTION OF THE INVENTION

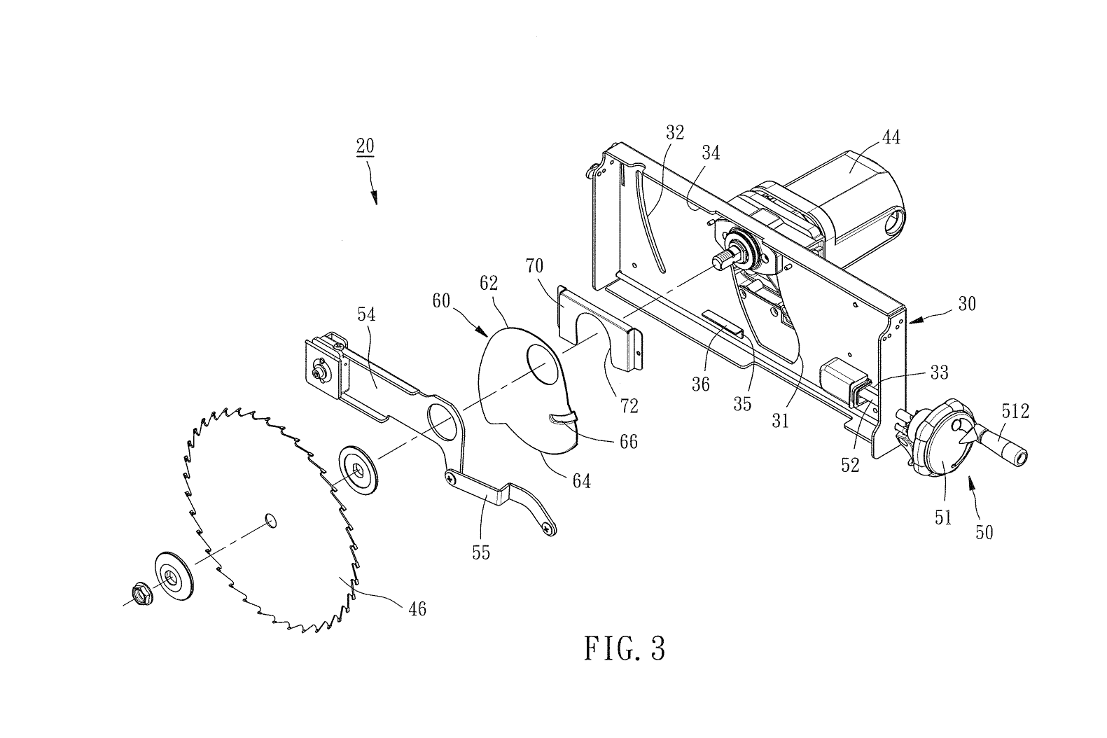

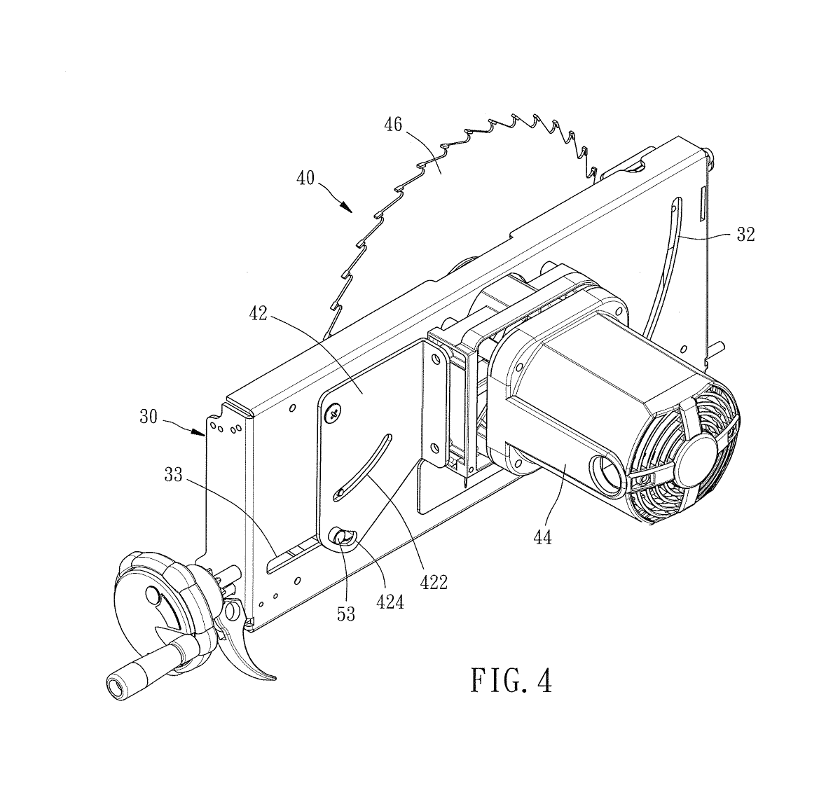

As shown in FIGS. 3 and 4, a saw assembly 20 in accordance with a preferred embodiment of the present invention comprises a bracket 30, a driving unit 40, a saw blade 46, an elevating unit 50, and a shield 60.

The bracket 30 has an inclined guide slot 31 at a middle thereof, a first curved guide groove 32 at a left side of the inclined guide slot 31, a horizontal guide groove 33 at a right side of the inclined guide slot 31, as shown in FIG. 4, a first stop portion 34 formed at a top side thereof and located adjacent to a top end of the inclined guide slot 31, and a second stop portion 36 formed by a folding edge of a stopper 35 fastened to a front surface of the bracket 30.

The driving unit 40 includes a retaining plate 42 having a right corner pivotally connected with a rear side of the bracket 30, a second curved guide groove 422 at a middle thereof, and a third curved guide groove 424 in communication with the horizontal guide groove 33 of the bracket 30, and a motor 44 fastened to a left side of the retaining plate 42 such that the motor 44 is swingable along the inclined guide slot 31 of the bracket 30 relative to the bracket 30 about the pivot point of the retaining plate 42.

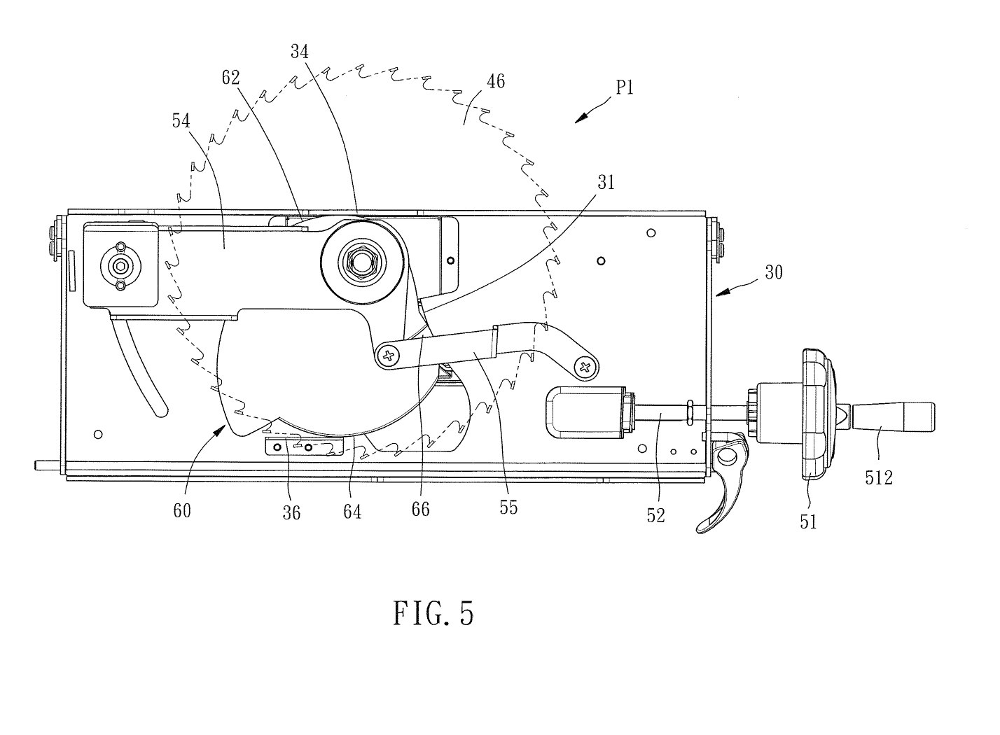

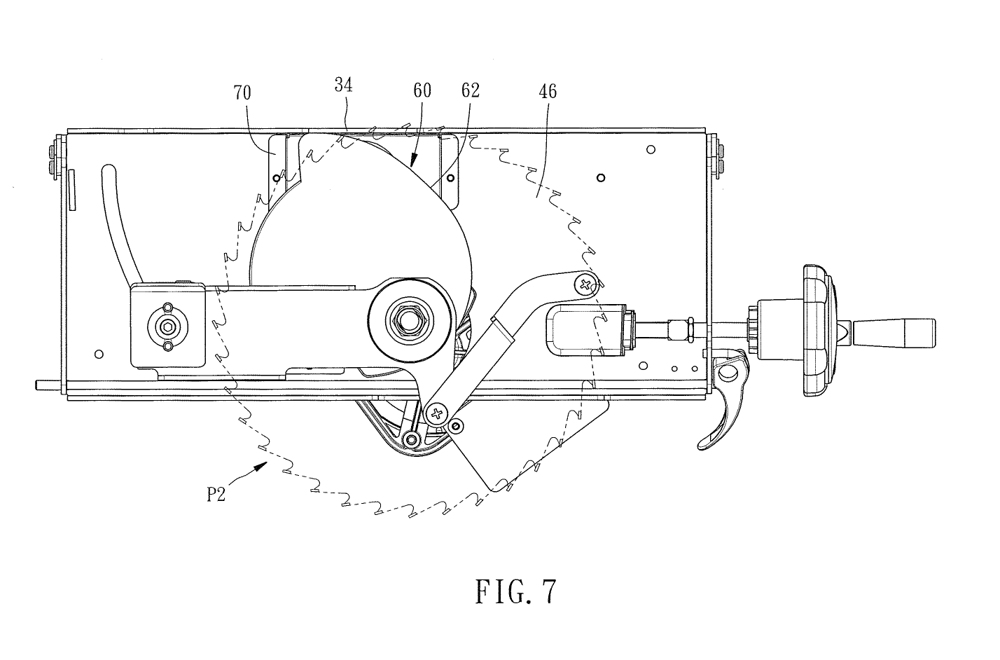

The saw blade 46 is coupled to a driving shaft of the motor 44, which passes through the inclined guide slot 31, such that the saw blade 46 is moveable along with the swing movement of the motor 44 between a working position P1, as shown in FIG. 5, and a rest position P2, as shown in FIG. 7.

The elevating unit 50 includes a wheel 51, a lead screw 52 having one end extending out of a right side of the bracket 30 and connected with the wheel 51 such that the lead screw 52 can be rotated by the actuation of the wheel 51, a nut 53 screwingly sleeved onto the other end of the lead screw 52 and having a protrusion engaged with the third curved guide groove 424 of the retaining plate 42 through the horizontal guide groove 33 of the bracket 30 such that the nut 53 is reciprocally moveable along the horizontal guide groove 33 of the bracket 30 by the actuation of the lead screw 52 for driving the swing movement of the driving unit 40, a first rod 54 having a through hole loosely coupled with the head of the motor 44 such that the first rod 54 is pivotally set between the motor 44 and the saw blade 46, and one end movably received in the first curved guide groove 32 of the bracket 30, and a second rod 55 having one end pivotally connected with the other end of the first rod 54, and the other end pivotally connected with the bracket 30 and inserted into the second curved guide groove 422 of the retaining plate 42, as shown in FIGS. 3 and 4.

The shield 60 has a through hole loosely coupled with the head of the motor 44 such that the shield 60 is pivotally set between the motor 44 and the saw blade 46 to cover the inclined guide slot 31 of the bracket 30, and a first curved edge 62 abutted against the first stop portion 34 of the bracket 30, a second curved edge 64 abutted against the second stop portion 36 of the bracket 30, and a forth curved guide groove 66 for insertion of a pivot joint between the first rod 54 and the second rod 55.

The structure of the saw assembly 20 is described as above, and the operation of the saw assembly 20 of the present invention is outlined hereinafter.

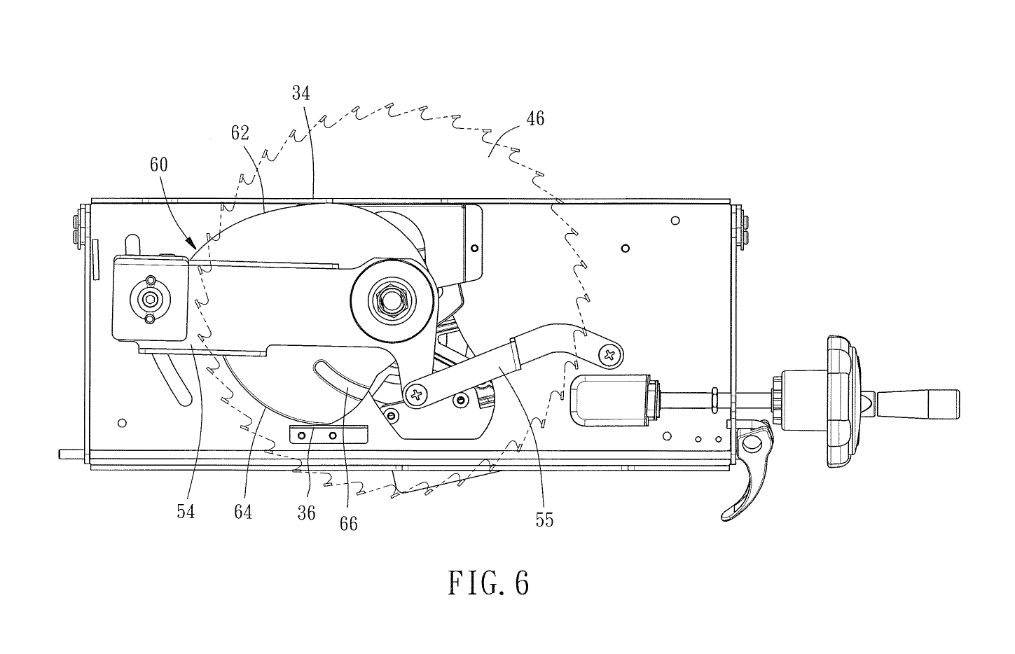

When a maintenance worker holds a handle 512 of the wheel 51 to drive the wheel 51 to rotate for moving the saw blade 46 from the working position P1 to the rest position P2, as shown in FIGS. 5 and 7, the lead screw 52 is rotated to drive the nut 53 to move toward a direction away from the driving unit 40. During the movement of the nut 53, the retaining plate 42 is pulled by the nut 53 to be swingingly moved, and meanwhile the motor 44 is swingingly moved along with the retaining plate 42, causing the saw blade 46 to be moved downwards to the rest position P2 along the inclined guide slot 31 of the bracket 30, as shown in FIGS. 4 to 7. During the movement of the saw blade 46, the shield 60 is rotated because the second curved edge 64 of the shield 60 is stopped against the second stop portion 36 of the bracket 30, and meanwhile the first curved edge 62 of the shield 60 won't be interfered with the first stop portion 34 of the bracket 30 because of having a suitable curvature; moreover, the pivot joint between the first rod 54 and the second rod 55 leaves the forth curved guide groove 66 of the shield 60 through the downward movement of the saw blade 46 and the pivotal movement of the shield 60. Accordingly, when the saw blade 46 is moved to the rest position P2, the inclined guide slot 31 of the bracket 30 is covered by the shield 60, and therefore the maintenance worker's hand can't pass through the inclined guide slot 31 to prevent from getting injured by the saw blade 46.

Besides, since the first curved edge 62 of the shield 60 is abutted against the first stop portion 34 of the bracket 30, the shield 60 is rotated when the saw blade 46 is elevated from the rest position P2 to the working position P1, and meanwhile the second curved edge 64 of the shield 60 won't be interfered with the second stop portion 36 of the bracket 30 due to the curvature design of the second curved edge 64. Furthermore, the pivot joint between the first rod 54 and the second rod 55 is inserted into the forth curved guide groove 66 of the shield 60 for avoiding interference among the shield 60, the first rod 54, and the second rod 55.

To deserve to be mentioned, a frame 70 can be further provided by the saw assembly 20 of the present invention to be fastened to the bracket 30 to cover the top end of the inclined guide slot 31. The frame 70 is provided with a notch 72 matched with the top end of the inclined guide slot 31, as shown in. FIGS. 3 and 7, for assisting the shield 60 in covering the inclined guide slot 31.

As indicated above, the shield 60 provided by the saw assembly 20 of the present can be used to cover the inclined guide slot 31 of the bracket 30 when the saw blade 46 is located at the working position P1 or the rest position P2 for preventing the maintenance work's hand from getting hurt by the saw blade 46, thereby attainting the purpose of enhancing safety of the maintenance work during repair work. In addition, the sawing chips of a workpiece can be stopped from passing through the inclined guide slot 31 of the bracket 30 by the shield 60 so as to be effectively collected.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A saw assembly for a table saw, comprising:
a bracket having an inclined guide slot, a first stop portion adjacent to a top end of the inclined guide slot, and a second stop portion adjacent to a bottom end of the inclined guide slot;
a driving unit swingingly connected with the bracket and having a driving shaft extending through the inclined guide slot of the bracket;
a saw blade coupled to the driving shaft of the driving unit;
an elevating unit mounted with the bracket and connected with the driving unit for driving the driving unit to swing such that the saw blade is reciprocally moveable along the inclined guide slot; and
a shield pivotally mounted between the driving unit and the saw blade, and covering the inclined guide slot of the bracket, and provided with two curved edges respectively abutted against the first and second stop portions of the bracket such that the shield is pivotable during a movement of the saw blade, thereby keeping the inclined guide slot of the bracket covered.

2. The saw assembly as claimed in claim 1, further comprising a frame fastened to the bracket, and located at the top end of the inclined guide slot; wherein the frame has a notch matched with the top end of the inclined guide slot.

3. The saw assembly as claimed in claim 1, wherein the elevating unit includes a first rod pivotally connected between the driving unit and the saw blade and having one end movably inserted into a curved guide groove of the bracket, and a second rod having one end pivotally connected with the bracket, and the other end pivotally connected with the first rod through a pivot joint insertable into a curved guide groove of the shield.

4. The saw assembly as claimed in claim 1, wherein the first stop portion is formed at a top side of the bracket.

5. The saw assembly as claimed in claim 1, wherein the second stop portion is formed by a folding edge of a stopper fastened to the bracket.

6. The saw assembly as claimed in claim 1, wherein the driving unit includes a retaining plate pivotally connected with the bracket, and a motor fastened to the retaining plate and provided with the driving shaft connecting the saw blade.
